(19) United States
(12) Patent Application Publication
(10) Pub. No.: US 2007/0266259 A1
(43) Pub. Date: Nov. 15, 2007

(54) Electronic Device and Access Control Method

(75) Inventor: Kazuyoshi UTSUMI, Okaya-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/744,101

(22) Filed: May 3, 2007

(30) Foreign Application Priority Data
May 9, 2006 (JP) 2006-129931
Apr. 3, 2007 (JP) 2007-097189

(51) Int. Cl. H04L 9/00

(52) U.S. Cl. 713/183

(57) ABSTRACT

An electronic device is configured to be able to access to a storage unit having a password-type lock function, and the electronic device includes: a memory unit for storing device information about the electronic device; and a storage driver for controlling access to the storage unit, wherein the storage driver creates a password based on the device information acquired by referring to the memory unit, and notifies the storage unit of the created password to set/cancel password-type lock.

### CROSS-REFERENCES TO RELATED APPLICATIONS

The entire disclosure of Japanese Patent Application No. 2006-129931, filed on May 9, 2006, and No. 2007-97189, filed on Apr. 3, 2007, is expressly incorporated herein by reference.

### BACKGROUND

1. Technical field

The present invention relates to a storage driver for controlling access to a storage unit having a password-type lock function, more particularly to an electronic device, such as a printer, having the storage driver.

2. Related Art

Recently, not only personal computers (PCs) but also electronic devices such as printers have large-capacity, nonvolatile storage units represented by a hard disk drive unit (hereinafter referred to as ‘HDD unit’), and the numbers of those kinds of devices are increasing.

There are several standards for storage units. Among them, the ATA (AT Attachment) standard adopts a function for restricting (locking) access to the storage unit by setting a password (hereinafter referred to as ‘password-type lock function’) (see JP-A-2004-78539).

A password set for the storage unit is usually input by a user. Meanwhile, the invention disclosed in JP-A-2004-78539 employs a configuration in which a password is automatically generated and set by a system BIOS using a random number table, for the purpose of removing the burden on a user of inputting a password.

A storage unit in printers or similar devices conforms to the same standard (e.g., ATA) that a storage unit in a personal computer (PC) conforms to. Therefore, if a storage unit is removed from a printer or similar and attached to a PC or similar, data stored in the storage unit can be accessed from the PC or similar.

However, the storage unit in a printer sometimes stores highly confidential data such as print data relating to confidential prints or valuable data such as font data or form data. If such data could easily be read via a PC just by removing the storage unit from the printer, information security cannot be considered as sufficient.

The inventors of the present application investigated maintenance of information security utilizing the above mentioned password-type lock function in the storage unit in printers, and realized the following problems.

Since data such as print data formats, font data, and form data is commonly used in the printers or similar of the same manufacturer or model, it is preferable that the storage unit storing those kinds of data can be used by any of those devices.

If a password is set or input by a user of those devices, the storage unit can be removed from one device and attached to another one, and then can be used in that device only by inputting the password. Accordingly, one storage unit can be used in several devices.

However, printers or similar devices are not usually provided with input interfaces, such as a keyboard, so it is difficult to employ a scheme in which a password is set and input by a user. Even if a device that is shared by a number of users has some kind of input interface, a user who knows the password for the device, is not always there when power for the device is turned on. Accordingly, management in which a user has to always input a password when using the storage unit in the device is not realistic.

Meanwhile, a user does not have to input a password in the scheme in which a password is automatically generated by a system BIOS using a random number table, like in JP-A-2004-78539. However, that scheme is inconvenient because a storage unit cannot be shared even by the same model/manufacturer printers or similar devices. Moreover, in the configuration disclosed in JP-A-2004-78539, a password is stored in not only the storage unit but also the main body of a printer or similar device. Therefore, the password can be obtained illegitimately from the main body of the printer or similar device. Also, the storage unit becomes inaccessible if the password stored in the main body of the printer or similar device is somehow erased or destroyed, and eternally lost.

### SUMMARY

An advantage of some aspects of the invention is the provision of a new technique with which, when a storage unit with a password-type lock function is provided to an electronic device such as a printer, a password does not have to be input by a user, but a password-type lock function can be used without directly storing the password in the main body of the electronic device, and the storage unit can be shared by electronic devices of the same model/manufacturer.

An electronic device according to an aspect of the invention is one that can access a storage unit having a password-type lock function. The electronic device includes a memory unit for storing device information about the electronic device, and a storage driver for controlling access to the storage unit. In the electronic device, the storage driver creates a password based on device information acquired by referring to the memory unit, and notifies the storage unit of the created password to set/cancel the password-type lock. It is preferable that the device information is at least one of a manufacturer name, model name, or serial number of the electronic device.

With that configuration, a user does not have to input a password to set/cancel the password when starting to use the storage unit. Since the password set for the storage unit is created based on the device information on the electronic device, a common password is used in electronic devices of the same manufacturer if the manufacturer name is used as the device information. As a result, the storage unit can be used by any of electronic devices of the same model/manufacturer. Meanwhile, a PC or a similar device that does not have that device information cannot create the password, and so cannot access the storage unit in which the password has been set. Accordingly, data security in the storage unit can be maintained at a high level.

Preferably, the electronic device is a printer having a print engine and a print control unit. The print control unit stores, via the storage driver, at least one of form data, font data, or print data in the storage unit.

A storage driver according to an aspect of the invention is a storage driver for controlling access to a storage unit having a password-type lock function. The storage driver creates a password based on device information about the electronic device the storage driver is installed in or is connected with, and notifies the storage unit of the above created password to set/cancel the password-type lock.

An access control method according to an aspect of the invention is an access control method for a storage unit with a password-type lock function. The method includes creating a password based on device information about an electronic device that can access to the storage unit, and notifying the storage unit of the above created password to set/cancel the password-type lock.

The access control method according to an aspect of the invention can be implemented by an information processing unit (computer) in the electronic device, and a program for the implementation can be installed or loaded via various media such as a CD-ROM, magnetic disk, semiconductor memory, or communication network. If a printer is assumed as the electronic device, the program may be distributed stored in a printer card or a printer option board.

The invention can provide a new technique with which, if a storage unit with a password-type lock function is attached to an electronic device such as a printer, a user does not have to input a password, while the password-type lock function can be used without directly storing the password in the main body of the electronic device, and the storage unit can be shared by electronic devices of the same model/manufacturer.

### BRIEF DESCRIPTION OF THE DRAWINGS

FIG. 1 is a block diagram showing the schematic configuration for a printer system according to an embodiment of the invention.

FIG. 2 is a block diagram showing the functional configuration for an information processing unit in a printer device 20.

FIG. 3 is a flowchart defining operations in a HDD driver 22.

### DESCRIPTION OF EXEMPLARY EMBODIMENTS

An embodiment of the invention will be described with reference to the drawings.

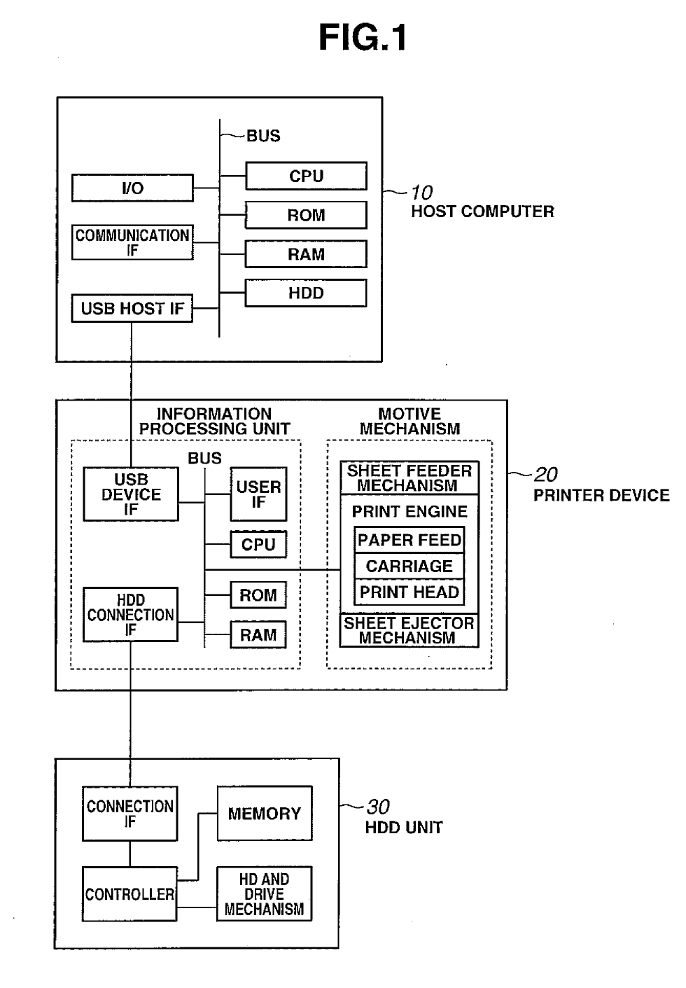

FIG. 1 is a block diagram showing the schematic configuration for a printer system according to an embodiment of the invention. As shown in FIG. 1, a host computer 10 is connected, via a USB (Universal Serial Bus) interface, to a printer device 20. A HDD unit 30 is installed in the printer device 20. The printer device 20 is configured to be capable of accessing the HDD unit 30 via a predetermined interface. The standard the predetermined interface conforms to is not limited to any particular one, so long as the standard supports a password-type lock function. The following description explains an example of the ATA.

Although the HDD unit 30 is outside the printer device 20 in FIG. 1, the printer device 20 may include the HDD unit 30 as one of its components.

The host computer 10 includes hardware such as a CPU (processor), ROM₁ RAM, an I/O controller, a communication interface, a USB host interface, and a HDD. The host computer 10 also includes, as its function, a printer driver for controlling the printer device 20.

The printer driver is similar to common printer drivers. In other words, the printer driver, after receiving a print request from a user specifying the printer device 20 via an application program operating externally or in the host computer 10, creates a print job based on a predetermined printer control language that can be interpreted by the printer device 20, and sends the print job to the printer device 20 connected to the host computer 10.

The print job may contain, in its header, job information such as a job ID, output destination printer model information, a user name (user ID), a print target document file name, print setting information (number of print sets, designation of single-side/double-side printing, and designation of color/monochrome, etc.).

The configuration of the printer device 20 is similar to that of common printers.

For example, the printer device 20 includes a motor mechanism having a sheet feeder mechanism for feeding sheets to the printer device, a print engine for executing printing, and a sheet ejector mechanism for ejecting sheets from the printer device, etc. The print engine usually includes a paper feed, a carriage mechanism, and a print head, etc. Various types of print engine corresponding to serial printers that execute printing in units of characters such as inkjet printers and thermal transfer printers, line printers that execute printing in units of lines, and page printers that execute printing in units of pages can be used.

In addition, for example, the printer device 20 has an information processing unit including hardware such as a CPU, ROM, RAM (which may be nonvolatile RAM), user interfaces such as a console panel, a USB device interface, and an ATA compatible HDD unit connection interface (which may be a HDD host controller, or a connector, etc).

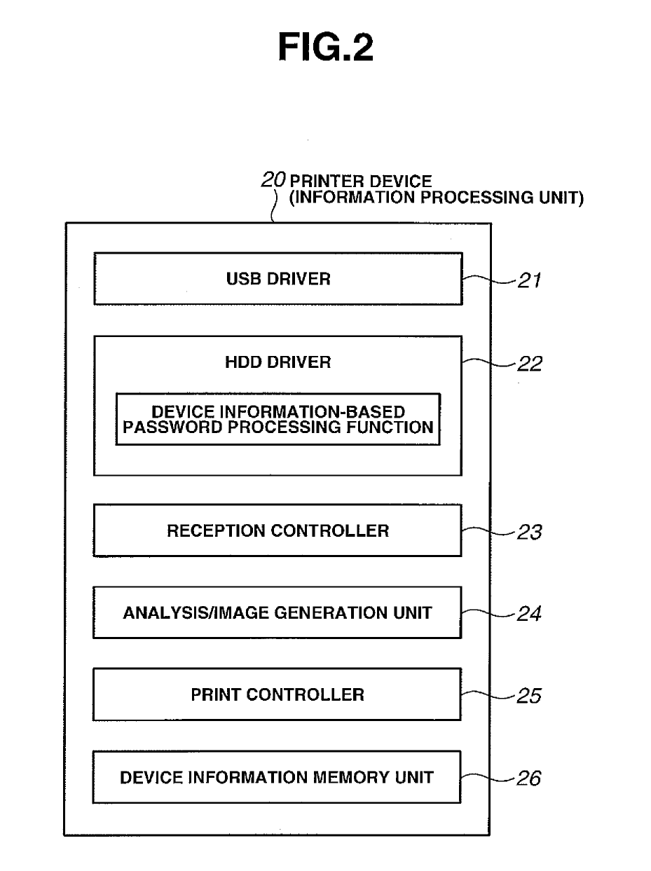

The information processing unit in the printer device 20 has the same functions as those in typical printer devices (see FIG. 2). For example, the information processing unit includes a USB driver 21 for controlling communication with the host computer 10 connected via the USB device interface, a HDD driver 22 for controlling access to the HDD unit 30 connected via the HDD unit connection interface, a reception controller 23 for receiving print jobs, commands, font data, or form data, etc., sent from the host computer 10 and storing it in the RAM or the HDD unit 30, an analysis/image generation unit 24 for generating, based on a print job and various kinds of data stored in the RAM or the HDD unit 30, raster print images for a band or a page and storing the raster print image in an image buffer, and a print controller 25 for transferring the print image for a predetermined unit (e.g. for a path) from the image buffer to the print engine and executing printing by controlling the print engine, etc.

Meanwhile, the printer device 20 according to this embodiment differs from typical printer devices on the following points. As shown in FIG. 2, in the information processing unit in the printer device 20 according to this embodiment, the memory unit 26, which is ROM or RAM, stores device information about the printer device 20 (for example, information unique to the manufacturer of the printer device 20, such as the manufacturer name and the model name, and information set by the manufacturer of the printer device 20, such as a serial number), and the HDD driver 22 has not only typical HDD driver functions, but also a device information-based password processing function for creating a password for the HDD unit 30 based on the device information acquired by referring to the memory unit 26, and notifying the HDD unit 30 of the above created password to set/cancel the password-type lock.

Each of those units and drivers is functionally realized (implemented) by having the CPU execute programs stored in the ROM or RAM in the printer device 20, or an external storage medium.

The HDD unit 30 has such hardware as a connection interface, a controller, a HD and its drive mechanism, ROM, and RAM, and various functions like those included in typical ATA compatible HDD units.

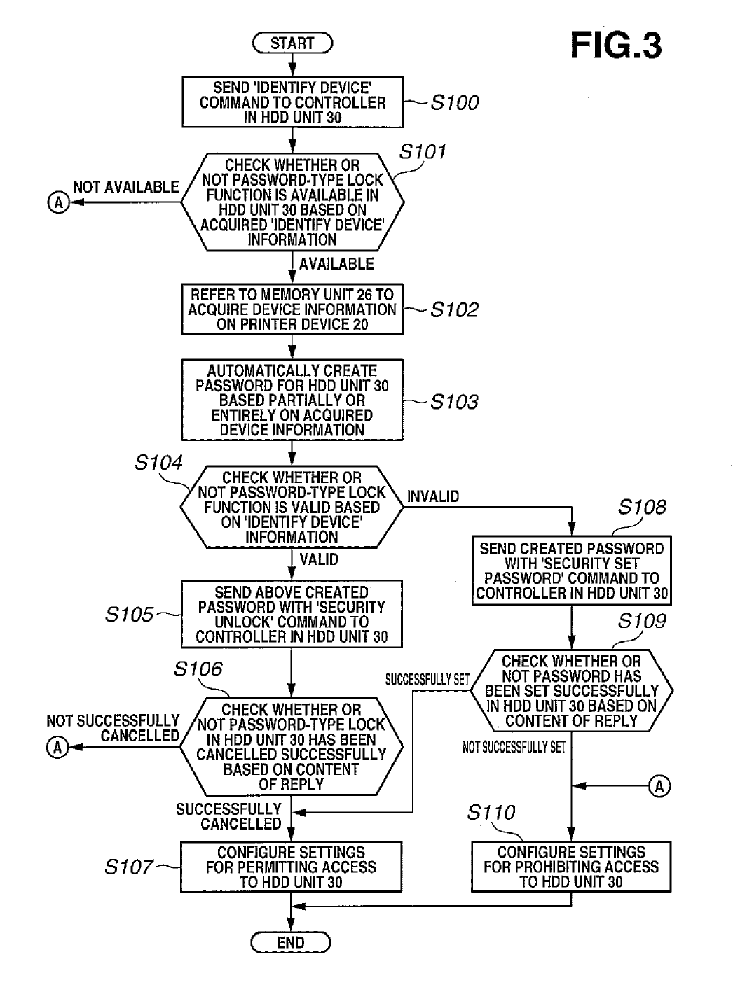

The device information-based password processing in this embodiment will be described below with reference to the flowchart in FIG. 3 defining the operations in the printer device 20 (the HDD driver 22). The order of steps (including partial steps without reference numbers) may be modified arbitrarily, or several steps may be executed at a time, so long as the content of the processing does not become contradictory. Although the HDD driver 22 has various functions, explanations for those not directly related to the device information-based password processing has been omitted.

The HDD driver 22 executes the following access control processing as part of initial (start-up) processing when the printer device 20 is turned on or reset.

The HDD driver 22 sends an ‘Identify Device’ command to the controller in the HDD unit 30 (S100).

The controller in the HDD unit 30, after receiving the command, refers to the ROM or nonvolatile RAM to read the serial number of the HDD unit 30 and information concerning the password-type lock function (whether or not the lock function is available; if available, whether or not the lock function is valid; and if valid, whether or not a access restriction status in the HDD is read-protected etc.), and sends, in reply to the command, the above read information as ‘Identify Device’ information to the HDD driver 22.

The HDD driver 22, after acquiring the ‘Identify Device’ information from the HDD unit 30, checks, based on the above acquired information, whether or not the password-type lock function is available in the HDD unit 30 (S101).

If the password-type lock function is not available in the HDD unit 30, the HDD driver 22 displays a message like: “No HDD password function. Use of HDD stopped.” on a console panel, configures the settings for prohibiting access to the HDD unit 30 (S110), e.g., notifies the reception controller 23 and the analysis/image generation unit 24 that the HDD unit 30 cannot be used, and then terminates the access control processing.

Meanwhile, if the password-type lock function is available in the HDD unit 30, the HDD driver 22 refers to the memory unit 26 to acquire the device information about the printer device 20 (S102), and automatically creates a password for the HDD unit 30 based partially or entirely on the device information (S103).

Conceivable examples of the method for creating the password include a method using an anagram. In that case, if the device information is the model name ‘LP-8000C,’ a password of ‘P08C0-L0’ can be created by simply interchanging the characters. In addition to simply interchanging the characters, a password can also be created by, for example, adding a predetermined value to each character's character code to change the characters to other ones, and then interchanging those different characters. Alternatively, various other types of typical methods using encryption techniques can be used for creating a password.

However, the password preparation logic (the order of interchanging characters, etc. in the method using an anagram) is fixed, so the same password is created in each processing.

In other words, a password is created according to the password preparation logic determined by the electronic device manufacturer based on the device information unique to an electronic device manufacturer (the manufacturer of the printer device 20 in this embodiment) or the device information set by an electronic device manufacturer.

Next, the HDD driver 22 checks whether or not the password-type lock function is valid based on the ‘Identify Device’ information (S104). Usually no password is set, and accordingly, the password-type lock function is invalid in the initial state before shipment.

If the password-type lock function is valid, the HDD driver 22 sends the above created password and a ‘security unlock command to the controller in the HDD unit 30 (S105).

The controller in the HDD unit 30, after receiving the ‘security unlock’ command, checks whether or not the password received with the command matches a password stored in the nonvolatile RAM or other types of memory in the HDD unit 30. If the passwords match, the controller in the HDD unit 30 changes the access restriction status in the HDD unit 30 from the read-protected state (the default value set when the power is turned on or the device reset) to the readable state, and notifies, in reply to the command, the HDD driver 22 that the password-type lock has been cancelled. Meanwhile, if the passwords do not match, the controller in the HDD unit 30 keeps the read-protected state in the HDD unit 30 and notifies the HDD driver 22 that the password-type lock was not able to be cancelled.

The HDD driver 22, after receiving the reply to the ‘security unlock’ command from the HDD unit 30, checks, based on the content of the reply, whether or not the password-type lock in the HDD unit 30 has been cancelled successfully (S106).

If the password-type lock has not been cancelled successfully, the HDD driver 22 displays a message like “Passwords incorrect. Use of HDD stopped.” on the console panel, configures the settings for prohibiting access to the HDD unit 30 (S100), and terminates the access control processing. After the access control processing is terminated, the above created password is not kept in the printer device 20 (for example, not stored in the nonvolatile RAM), and is abandoned.

If the password-type lock has been cancelled successfully, the HDD driver 22 notifies the reception controller 23 and the analysis/image generation unit 24 that the HDD unit 30 can be used (Si 07), and terminates the access control processing. In this step too, the above created password is not kept, and is abandoned.

Using the above described processing sequence, the printer device 20 can store the print job, etc. received from the host computer 10 in the HDD unit 30, read the print job, etc. from the HDD unit 30 at a predetermined point in time, generate a raster print image for a band or a page based on the print job, and font data, etc., store the raster print image in the image buffer, transfer the print image in a predetermined unit (i.e., for a path) from the image buffer to the print engine, and execute printing by controlling the print engine.

Meanwhile, if the password-type lock function is invalid, the HDD driver 22 sends a ‘security set password’ command and the above created password to the controller in the HDD unit 30 (S108).

The controller in the HDD unit 30, after receiving the ‘security set password’ command, stores the password received with the command in the nonvolatile RAM or other types of memory in the HDD unit 30 and validates the password-type lock function. After the password-type lock function is validated, the access restriction status in the HDD unit 30 becomes the read-protected state, which is the default value set when the device is turned on or reset. Next, the controller in the HDD unit 30 notifies, in reply to the command, the HDD driver 22 that the password has been set. Meanwhile, if the password-type lock function could not be validated for some reason, e.g., for the reason that the password could not be stored (the password could not be set), the controller in the HDD unit 30 keeps the password-type lock function invalid and notifies the HDD driver 22 that the password could not be set.

The HDD driver 22, after receiving the reply to the ‘security set password’ command from the HDD unit 30, checks, based on the content of the reply, whether or not the password has been set successfully (S109).

If the password has not been set successfully, the HDD driver 22 displays a message such as “Password not set successfully. Use of HDD stopped.” on the console panel, configures the settings for prohibiting access to the HDD unit 30 (S110), and terminates the access control processing.

Meanwhile, if the password has been set successfully, the HDD driver 22 sets permission for access to the HDD unit 30 (S107), and terminates the access control processing.

As described above, the printer device 20 (the HDD driver 22) has a device information-based password processing function for creating a password for the HDD unit 30 based on the device information about the printer device 20 stored in the memory unit 26, and notifying the HDD unit 30 of the created password to set/cancel the password-type lock. Accordingly, a user does not have to input a password for password setting/cancellation in the HDD unit 30.

Since the password created by the HDD driver 22 is not kept in the printer device 20, but abandoned after the termination of the access control processing, the password created by the HDD driver 22 cannot virtually be obtained by analyzing the main body of the printer device 20. Thus password leakage can be prevented.

Since the password set for the HDD unit 30 is derived from the device information about the printer device 20 in a predetermined manner, a password is shared by printer devices with the same device information (e.g., same manufacturer/model printer devices). As a result, a HDD unit can be used by any of those printer devices.

Meanwhile, the password cannot be acquired by PCs or similar devices that do not have the same device information, so those PCs or devices cannot access the HDD unit 30 the password has been set for. As a result, the security of data in the HDD unit 30 can be maintained at a high level. If the HDD unit 30 has to be accessed from a particular PC or similar device for the purpose of repair, etc., all that is required is installation in that PC or device of both the device information about the printer device 20 and the password preparation logic.

### MODIFIED EXAMPLE

The invention is not limited to the above embodiment, but may be modified in various ways. For example, the host computer 10 and the printer device 20 may be connected according to any standard (protocol) other than USB.

In the above embodiment, a printer device is used as an electronic device. However, the invention can also be used in copy machines, facsimiles, scanner and complex machines, etc. In the case of a facsimile, it is possible that highly confidential data, such as client's telephone directory, is stored in a HDD unit 30, which is also used by other facsimiles of the same model. Therefore, a great advantage can be obtained by using the invention.

Part of, or the entire HDD driver 22 may be realized by hardware, or may be realized as a function of an OS or BIOS mounted on an electronic device.

In the above embodiment, the HDD driver 22 stops the use of the HDD unit 30 (prohibits access to the HDD unit 30) if the password-type lock function is not available in the HDD unit 30 or if the password-type lock function cannot be set valid. However, use of the HDD unit 30 may be alternatively permitted in that case. Also, in the above embodiment, the HDD driver 22 stops use of the HDD unit 30 (i.e., prohibits access to the HDD unit 30) if the HDD unit 30 cannot cancel the password-type lock on the HDD unit 30. However, since the HDD unit 30 cannot be accessed anyway when the password-type lock has not been cancelled, the HDD driver 22 does not have to actively stop the use of the HDD unit 30.

In the above embodiment and modified example, a HDD unit is used as an example of a storage unit. However, any other large-capacity nonvolatile storage unit, such as USB memory, a memory card, or a DVD, etc., that can be attached to electronic devices, can be used in the invention.

What is claimed is:

1. An electronic device configured to be able to access a storage unit having a password-type lock function, the electronic device comprising:
a memory unit for storing device information about the electronic device; and
a storage driver for controlling access to the storage unit,
wherein the storage driver creates a password based on the device information acquired by referring to the memory unit, and notifies the storage unit of the created password to set/cancel password-type lock.

2. The electronic device according to claim 1, wherein the electronic device is a printer having a print engine and a print control unit, and the print control unit stores at least one of form data, font data, or print data in the storage unit via the storage driver.

3. The electronic device according to claim 1, wherein the device information is at least one of a manufacturer name, a model name, or a serial number of the electronic device.

4. A storage driver for controlling access to a storage unit having a password-type lock function, the storage driver creating a password based on device information about an electronic device the storage driver is installed in, and notifying the storage unit of the created password to set/cancel password-type lock.

5. An access control method for a storage unit having a password-type lock function, the method comprising:
creating a password based on device information about an electronic device configured to be able to access the storage unit; and
notifying the storage unit of the created password to set/cancel password-type lock.

6. A program for executing the access control method according to claim 5.
